(19) United States
(12) Patent Application Publication
(10) Pub. No.: US 2025/0205523 A1
(43) Pub. Date: Jun. 26, 2025

(54) WEAR GUARD FOR WOOD POLE FALL PROTECTION DEVICE

(71) Applicant: Buckingham Manufacturing Company, Inc., Binghamton, NY (US)

(72) Inventor: Kevin Truesdell, Binghamton, NY (US)

(73) Assignee: Buckingham Manufacturing Company, Inc., Binghamton, NY (US)

(21) Appl. No.: 18/999,886

(22) Filed: Dec. 23, 2024

Related U.S. Application Data
(60) Provisional application No. 63/614,056, filed on Dec. 22, 2023.

(51) Int. Cl. A62B 35/00

(52) U.S. Cl. CPC A62B 35/0075

(57) ABSTRACT

A wear guard for a wood pole fall restriction assembly is described to protect locations of an outer strap where the relatively most sever wear occurs through use when being dragged or rubbed against a pole or other structure, or other component of the wood pole fall protection assembly/system. In some examples, the wear guard has a substantially similar width as the outer strap and has a slight bend to accommodate a D-ring included with the assembly.

### BACKGROUND OF THE INVENTION

### 1. Field of the Invention

The present invention relates to pole climbing equipment and, more particularly, to a wood pole fall protection device for linemen and pole climbers that includes a wear guard to protect the safety, integrity, and longevity of the device.

### 2. Description of the Related Art

Wood pole fall protection devices, when used in conjunction with a lineman's body belt and retractable lanyard to form a wood pole fall protection assembly/system, protect a user from experiencing dangerous falls and sustaining injuries while working upon, positioning upon, ascending, or descending the pole. Examples of such devices are shown and described in U.S Pat. Nos. 6,752,242, 8,544,603, and 10,207,151.

Description of the Related Art Section Disclaimer: To the extent that specific patents/publications/products are discussed above in this Background Section or elsewhere in this Application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products (and/or specific portions thereof) are discussed above in this Background Section and/or throughout the application, the descriptions/disclosures of which are all hereby incorporated by reference into this document in their respective entirety(ies) (or at least the specific references sections are incorporated by reference into this document in their respective entirety(ies), as may be applicable).

### BRIEF SUMMARY OF THE INVENTION

There are certain drawbacks associated with conventional or standard wood pole fall protection devices. The outer strap can become worn and frayed with use (per extended contact with a pole or other devices/structure) which can compromise the safety, integrity, and/or longevity of the device.

The inventors recognize that there is a need in the art for a wear guard component to protect areas of much of or the most wear on the outer strap of a wood pole fall protection device. The present disclosure addresses this need by providing a wear guard component to protect locations of the outer strap where the relatively most severe wear occurs through use when being dragged or rubbed against a pole or other structure, or other component of the wood pole fall protection assembly/system.

### BRIEF DESCRIPTION OF THE SEVERAL VIEWS OF THE DRAWING(S)

The present disclosure will be more fully understood and appreciated by reading the following Detailed Description in conjunction with the accompanying drawings. The accompanying drawings illustrate only typical embodiments of the disclosed subject matter and are therefore not to be considered limiting of its scope, for the disclosed subject matter may admit to other equally effective embodiments. Reference is now made briefly to the accompanying drawings, in which:

FIG. 1 is a perspective view of a wood pole fall protection assembly without a wear guard.

FIG. 2 is a perspective view of a wood pole fall protection assembly without a wear guard.

FIG. 3 is a perspective view of a wood pole fall protection assembly without a wear guard.

FIG. 4 is a perspective view of a wood pole fall protection assembly without a wear guard.

FIG. 5 is a perspective view of a wood pole fall protection assembly without a wear guard.

FIG. 6 is a perspective view of a wood pole fall protection assembly without a wear guard.

FIG. 7 is a close-up view of the wear guard for wood pole fall protection assembly according to an aspect of the present disclosure.

FIG. 8 is another close-up view of the wear guard for wood pole fall protection assembly according to an aspect of the present disclosure.

FIG. 9 is a close-up view of the wear guard for wood pole fall protection assembly in use according to an aspect of the present disclosure.

FIG. 10 is another close-up view of the wear guard for wood pole fall protection assembly in use according to an aspect of the present disclosure.

FIG. 11 is a perspective view of the wear guard for wood pole fall protection assembly in use according to an aspect of the present disclosure.

FIG. 12 is another perspective view of the wear guard for wood pole fall protection in use according to an aspect of the present disclosure.

FIG. 13 is another close-up view of the wear guard for wood pole fall protection in use according to an aspect of the present disclosure.

Where applicable, like reference characters designate identical or corresponding components and units throughout the several views, which are not to scale unless otherwise indicated. Moreover, the embodiments disclosed herein may include elements that appear in one or more of the several views or in combinations of the several views.

### DETAILED DESCRIPTION

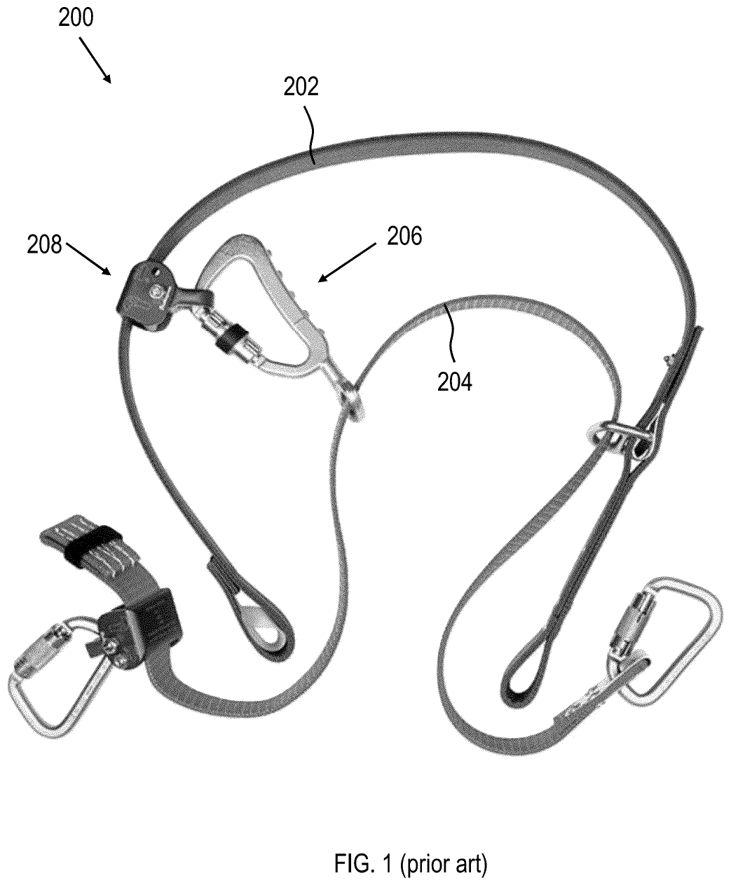

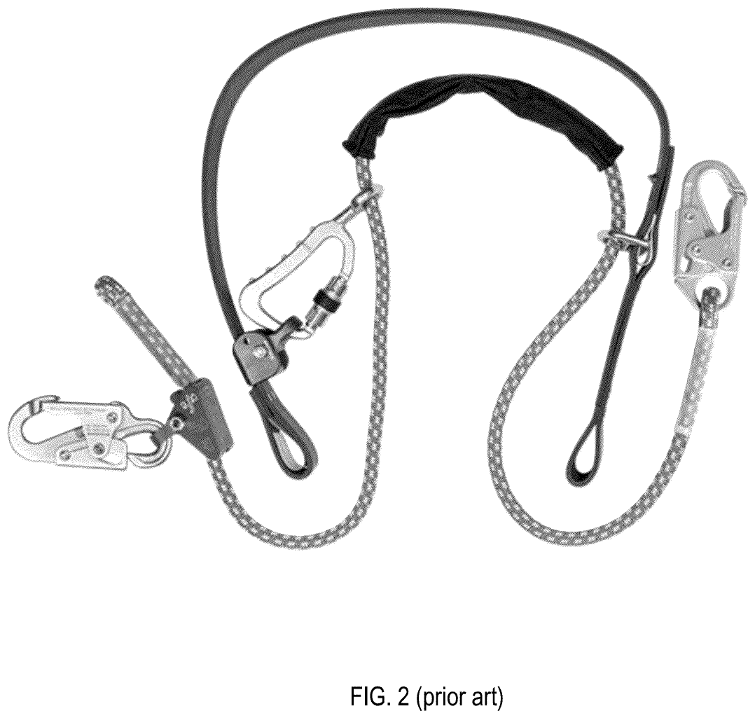

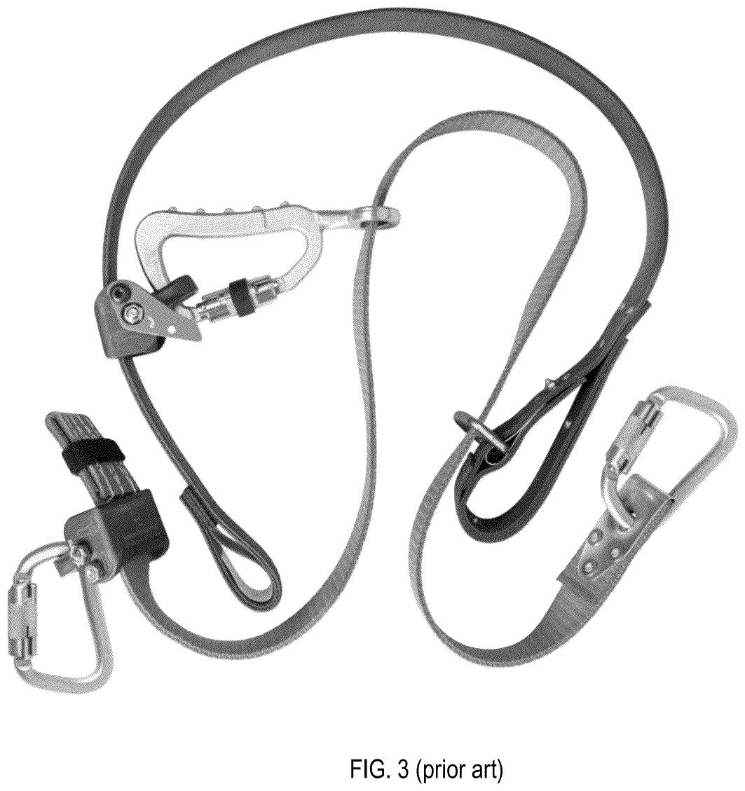

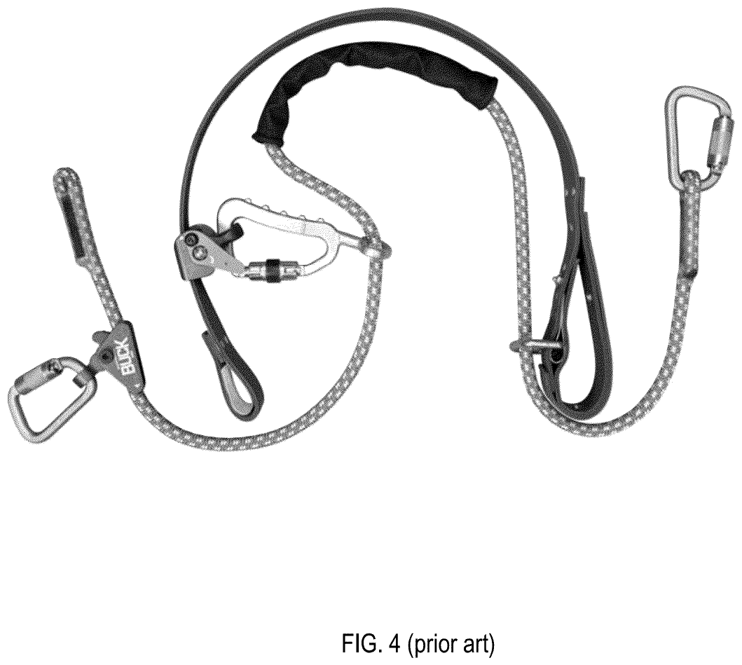

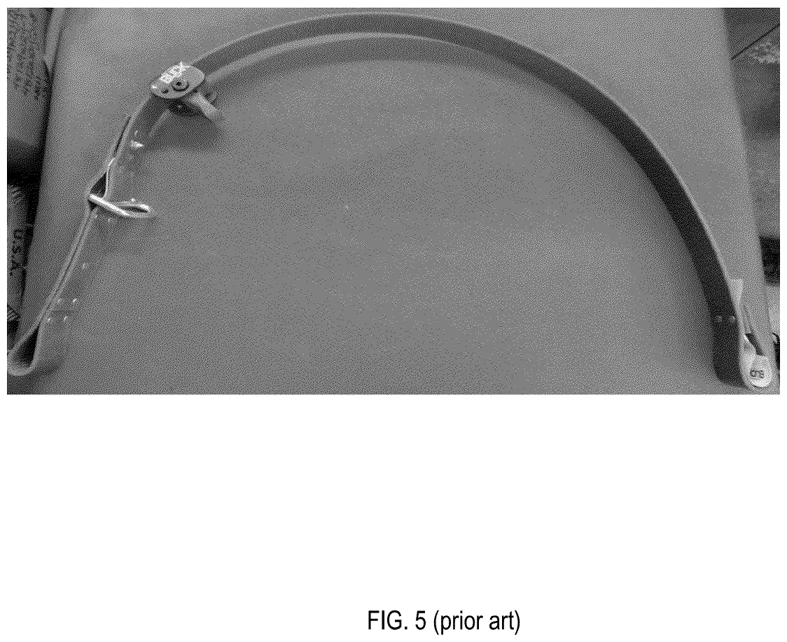

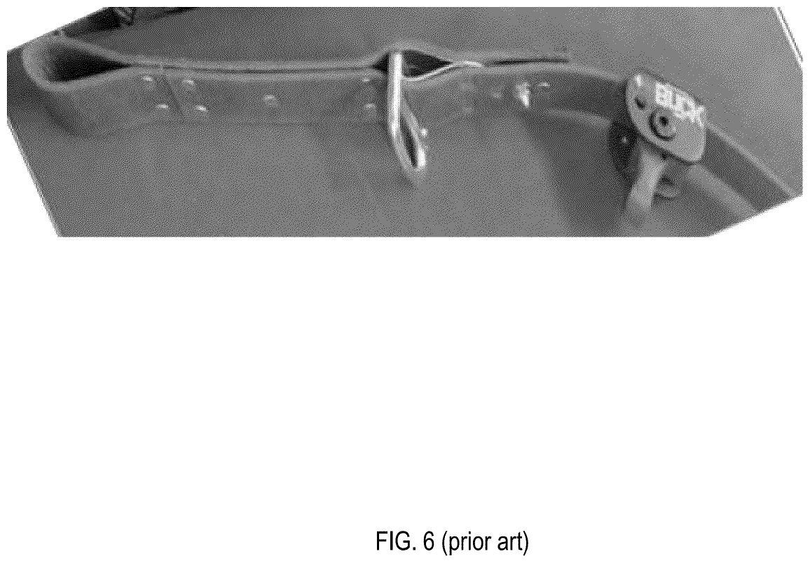

Referring to the figures, wherein like numerals refer to like parts throughout, there is seen in FIGS. 1-6 examples of various wood pole fall protection devices 200 without wear guards. These devices can include, for example and illustrative purposes, an outer strap 202, an inner strap/lanyard 204 connected to the outer strap 202, a connector 206 for interconnecting it to a body belt/harness worn by the pole climber (not shown), and an adjustable connector assembly 208 interconnecting the inner strap or lanyard 204 to the outer strap 202.

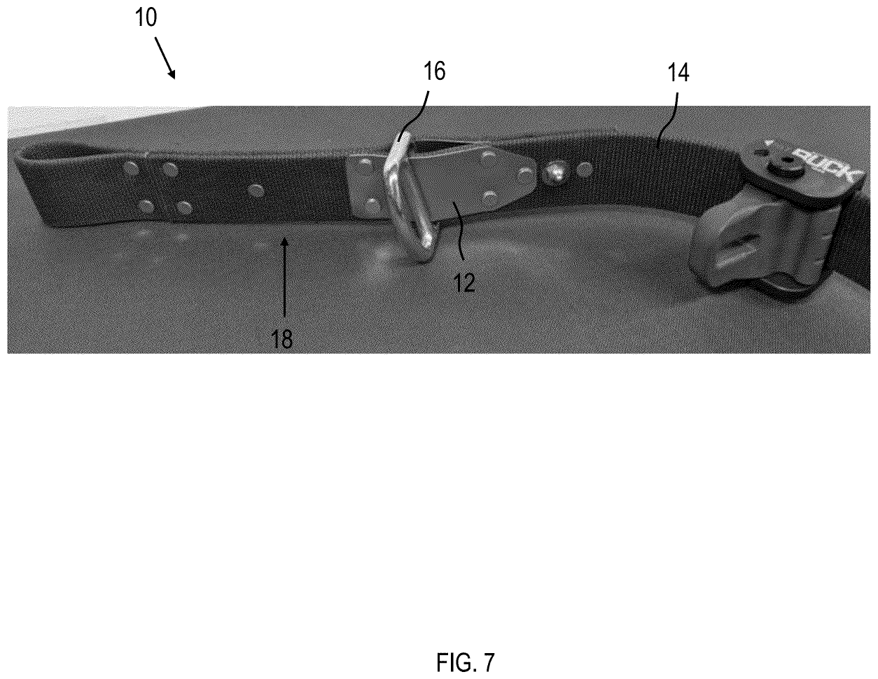

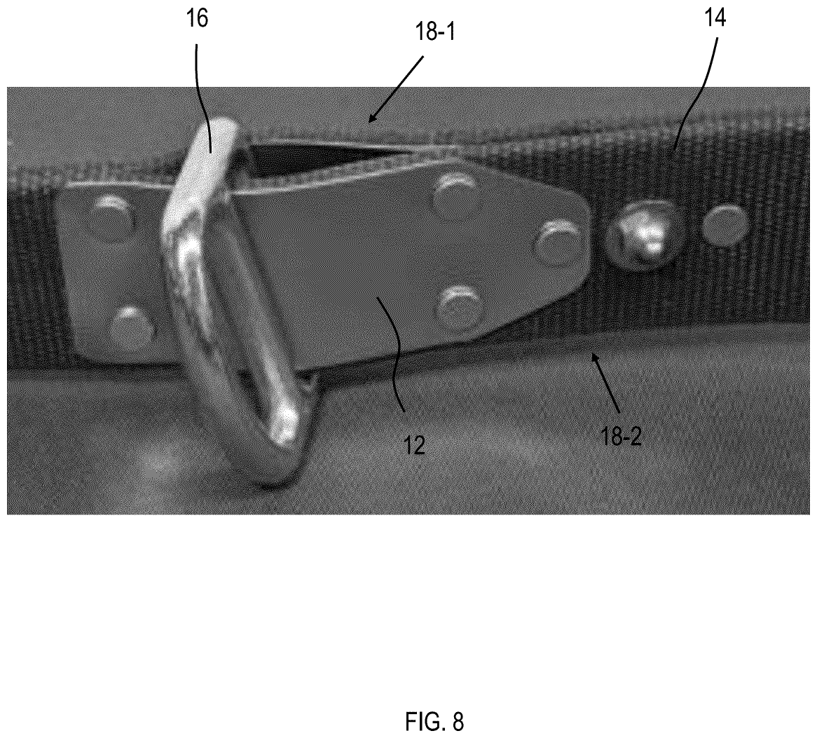

Referring to FIGS. 7-8, the wear guard for wood pole fall protection assembly 10 is shown. A wear guard 12 can be attached by a mechanism (in this example rivets, but can also include but not be limited to tape, glue, or other adhesive or attachment components sufficient to attach the wear guard to the strap 14 as should be understood by a person of ordinary skill in the art in conjunction with a review of this disclosure) to an outer surface of the outer strap 14 (or any other component of the wood pole fall protection assembly/system 10) where wear is deemed to occur most frequently or most severely, and can conform to the shape of the component (e.g., as shown below, the wear guard component 12 has a substantially similar width as the outer strap 14 and has a slight bend to accommodate a D-ring 16 shown connected to the outer strap 14).

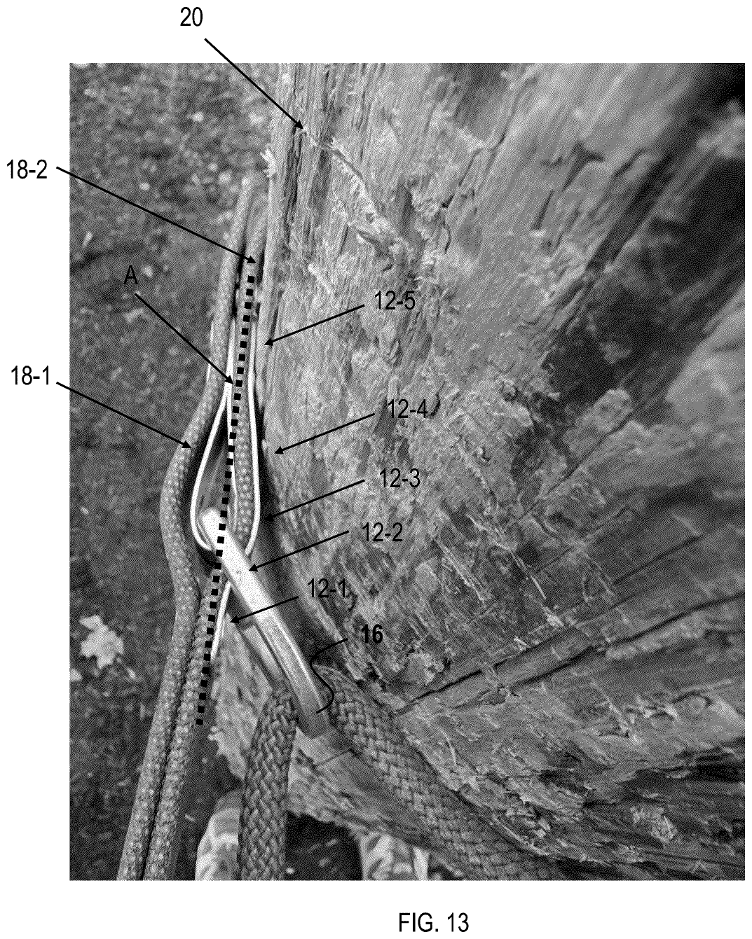

As shown in FIG. 8, for example, a first segment 18-1 of a folded over portion 18 of the outer strap 14 passes around a D-ring 16 such that the D-ring 16 is positioned between the first and second segments 18-1 and 18-2 of the folded over portion 18 of the outer strap 14. In this example, the inner surfaces of the first and second segments 18-1 and 18-2 are reinforced with a hard material (including but not limited to metal (including steel, as shown) plastic, polymer, or the like) on at least a portion of the inner surfaces thereof. This reinforcement can prevent the D-ring 16 from tearing through the strap 14 due to the pulling force on the D-ring 16 from a user's weight (see, e.g., FIG. 13). The term D-ring is intended to include any and all possible shapes and sizes of attachment rings consistent with the definition found in ASTM F887-2023 Section 3.1.10. In a preferred embodiment, the D-rings shown and described in the particular figures herein can range in size from 1½″ to 4″ wide and 1″ long to 6″ long, for example. In a preferred embodiment, the D-rings are made of aluminum or steel.

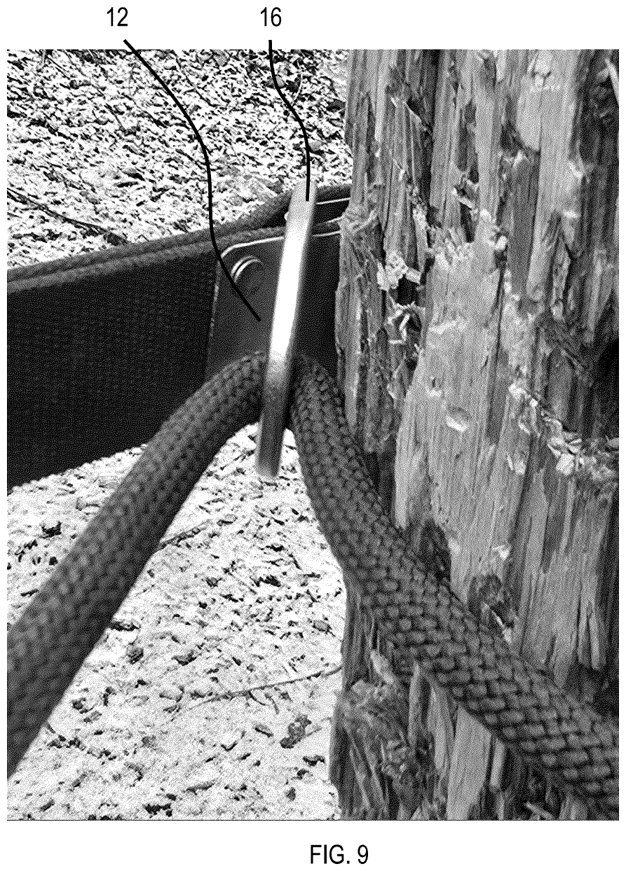

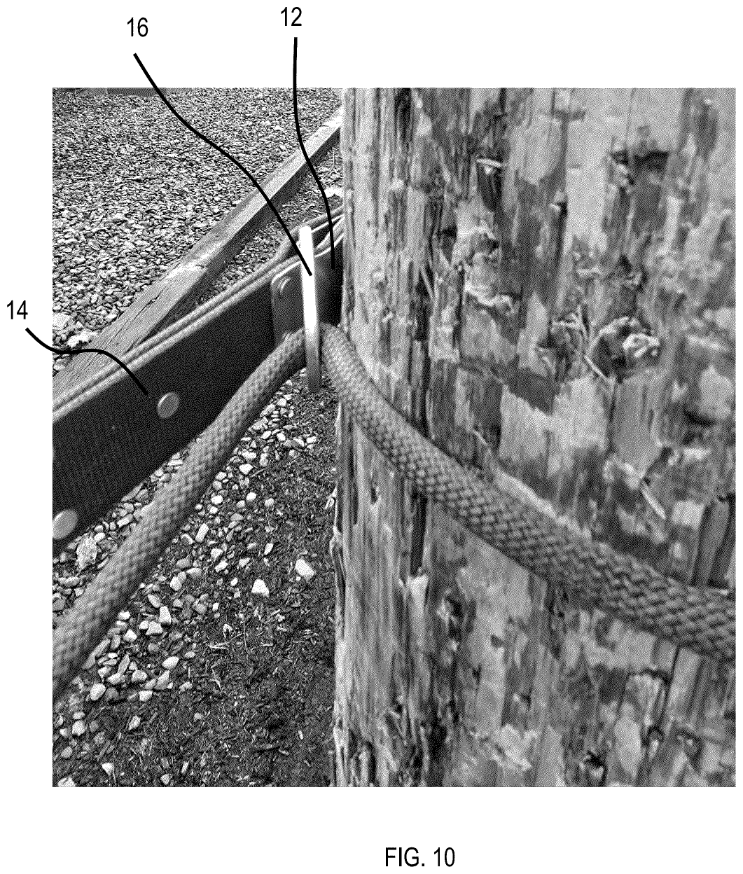

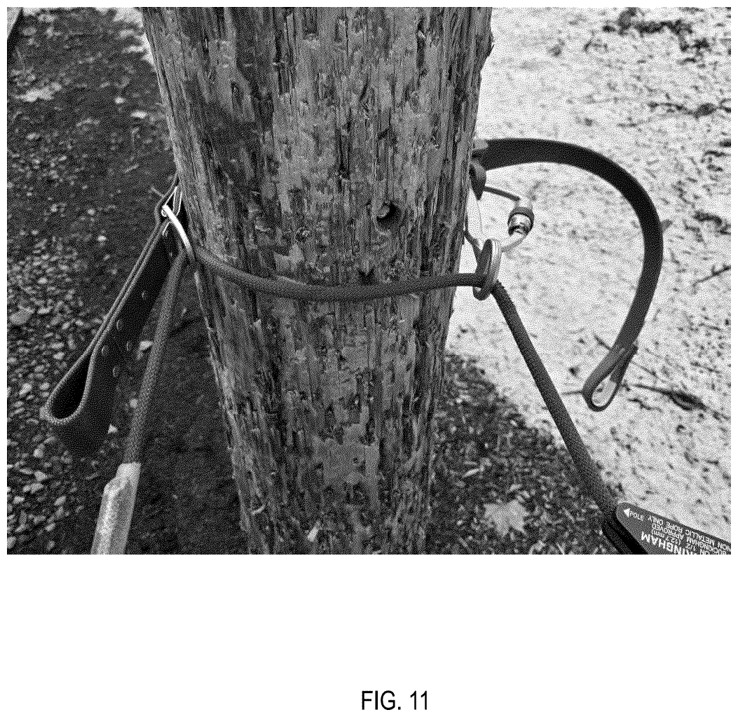

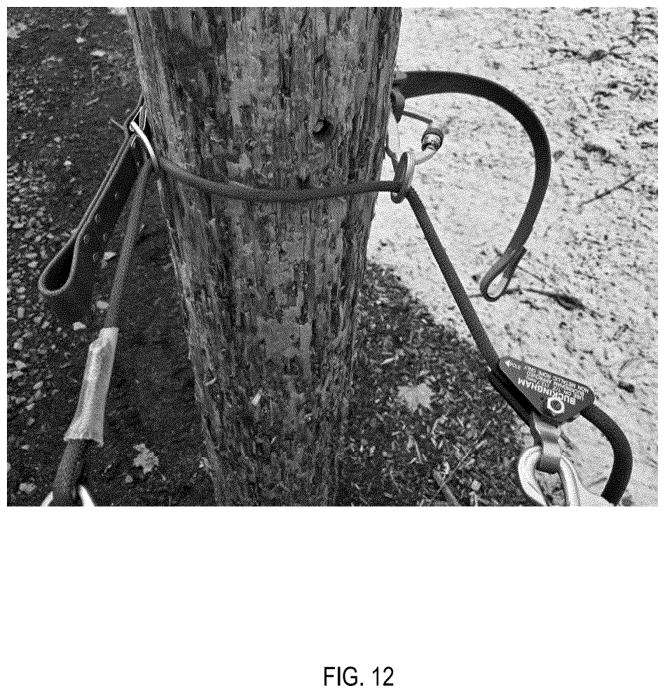

Referring now to FIGS. 9-13, the wear guard for wood pole fall protection assembly 10 is shown in use. In this embodiment, the wear guard component 12 can be added to any key location (i.e., relatively high wear location based on use, and as should be understood by person of ordinary skill in the art in conjunction with a review of this disclosure) of a wood pole fall protection assembly/system and can be of any length (preferably of a length corresponding with the contact area between the outer strap and the pole). As shown, the wear guard 12 is positioned along the strap 14 of the wood pole fall protection assembly 10 at a position that corresponds to and is in contacting relation with the pole 20 that the system is being wrapped around. The wear guard 12 can act as a barrier between the pole 20 and the strap 14 at the point of contact to prevent friction while in use (i.e., a user ascending and descending a pole), thereby extending the longevity of the assembly and improving safety. In this embodiment and as shown, the wear guard 12 has a slight curve to accommodate the D-ring 16 at one end and conform to the contours of the pole 20 at the other end, as discussed below. In a preferred embodiment, the wear guard 12 is 1⅝″ by 4″, for example, and can be formed of any metal (including steel, as shown), plastic, polymer, or the like (as should be appreciated by a person of ordinary skill in the art in conjunction with a review of this disclosure). The rest of the structure of the wood pole fall protection assembly/system can remain the same, as shown in embodiments described above.

In some embodiments, the wear guard 12 can be shaped such that it can be referred to into different segments (see, e.g., FIG. 13). The first segment 12-1 and the fifth segment 12-5 can extend along or substantially along (varying by 0-10 degrees) a first plane A (i.e., the most distal and most proximal ends). The second segment 12-2 can be curved slightly and extend away from and at an angle to the first plane A and toward the pole 20 so that the position of the D-ring 16 with respect to the outer strap 14 during use (i.e., the pulling force on the D-ring 16 caused by the user's weight) is not obstructed by the wear guard 12. The third segment 12-3 can taper toward the fourth segment 12-4 and toward the first plane A to accommodate the circumference of the pole 20 as the user moves the assembly up and down the pole 20. The angles of each segment with respect to the first plane can vary depending on the force and direction of force applied to the D-ring 16 and the size/shape of the two segments 18-1 and 18-2 of the outer strap 14 that the D-ring 16 is positioned between, as should be understood by a person of ordinary skill in the art in conjunction with a review of this disclosure (for example, the angle between segment 12-4 can increase with respect to the first plane when the D-ring is pulled to the right).

In some embodiments, the wear guard 12 is malleable and the shape/contouring can change based on the amount of force and direction of force applied to the strap (e.g., a user's weight or the circumference of the pole). In other embodiments, the wear guard 12 can be manufactured to meet (and in some embodiments, remain, in view of the composition used) a user's preference or is contoured in such a way that allows it to be used with conventionally sized poles.

In accordance with an alternative embodiment, the wear guard component 12 can be integrally formed as part of the outer strap 14 or other component (i.e., by being formed of a different and relatively stronger composition at the point of contact as compared to the remainder of the outer strap, such as Kevlar®, Dyneema®, or other aramid fibers).

In accordance with another alternative embodiment, the assembly 10 does not include a D-ring positioned within the folded over portion; a second connector can be provided on the other side of the strap 14 that the D-ring can attach to, for example. In this embodiment, the angles of each segment of the wear guard 12 with respect to the first plane can vary from the angles described above since the amount and direction of force would differ with the different positioning of the D-ring (and therefore force), as should be understood by a person of ordinary skill in the art in conjunction with a review of this disclosure, but the position of wear on the outer strap can remain the same (i.e., can follow the same logic as described above).

It should be understood that the metal wear guard is intended to be used on any wood pole fall protection system, with examples detailed above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as, “has” and “having”), “include” (and any form of include, such as “includes” and “including”), and “contain” (any form of contain, such as “contains” and “containing”) are open-ended linking verbs. As a result, a method or device that “comprises”, “has”, “includes” or “contains” one or more steps or elements. Likewise, a step of method or an element of a device that “comprises”, “has”, “includes” or “contains” one or more features possesses those one or more features but is not limited to possessing only those one or more features. Furthermore, a device or structure that is configured in a certain way is configured in at least that way but may also be configured in ways that are not listed.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A wood pole fall protection assembly, comprising:
an elongated outer strap having a folded over portion comprising a first segment and a second segment;
a wear guard positioned on the outer strap at a point of contact between the outer strap and a pole during use; and
a D-ring positioned and secured between the first and second segments of the folded over portion of the outer strap such that at least a portion of the wear guard and one segment of the folded over portion pass through the D-ring.

2. The wood pole fall protection assembly of claim 1, further comprising a first loop at a first end of the outer strap formed by the folded over portion and a second loop at a second end of the outer strap at least partially comprised of the outer strap.

3. The wood pole fall protection assembly of claim 2, further comprising an inner strap/lanyard adjustably connected to the first loop and comprising a connector for interconnecting to an outer climber.

4. The wood pole fall protection assembly of claim 3, further comprising an adjustable connector assembly interconnecting the inner strap/lanyard at a position distal to the second loop to the outer strap.

5. The wood pole fall protection assembly of claim 1, wherein the two segments of the folded over portion are secured to one another by rivets.

6. The wood pole fall protection assembly of claim 1, wherein the wear guard is attached to the outer strap by rivets.

7. The wood pole fall protection assembly of claim 1, wherein the wear guard is of a width that is substantially similar to a width of the outer strap.

8. The wood pole fall protection assembly of claim 1, wherein the wear guard is made of metal.

9. The wood pole fall protection assembly of claim 1, wherein the wear guard is integrally formed with the outer strap.

10. The wood pole fall protection assembly of claim 1, wherein the wear guard further comprises a first end, a second end, and a center portion, wherein the first end and the second end extend substantially along a first plane and the center portion is curved away from the first plane.

11. A wood pole fall protection assembly, comprising:
an elongated outer strap;
a wear guard positioned on the outer strap; and
a D-ring positioned and secured to the outer strap such that at least a portion of the wear guard passes through the D-ring.
